(19) United States
(12) Patent Application Publication
(10) Pub. No.: US 2014/0017020 A1
(43) Pub. Date: Jan. 16, 2014

(54) DIE STOCK

(71) Applicant: HARTMETALL-WERKZEUGFABRIK PAUL HORN GMBH, TUEBINGEN (DE)

(72) Inventor: MATTHIAS LUIK, REUTLINGEN (DE)

(21) Appl. No.: 14/015,337

(22) Filed: Aug. 30, 2013

Related U.S. Application Data
(63) Continuation of application No. PCT/EP2012/053468, filed on Feb. 29, 2012.

(30) Foreign Application Priority Data
Mar. 2, 2011 (DE) 10 2011 013 789.0

(51) Int. Cl. B23G 5/04; B23G 1/44

(52) U.S. Cl. CPC B23G 5/04; B23G 1/44
USPC 408/197; 408/239 R; 408/199

(57) ABSTRACT

The disclosure relates to a die stock comprising: an annular holder having a plurality of receiving grooves; a plurality of cutting inserts; and one fixture per cutting insert for axially fixing the respective cutting insert in one of the plurality of receiving grooves. The plurality of receiving grooves are provided on an inner periphery of the annular holder and run in an axial direction parallel to a central longitudinal axis of the annular holder. Each of the plurality of receiving grooves has a receiving groove profile for receiving one of the plurality of cutting inserts. Each cutting insert is received within a respective one of the receiving grooves and comprises at least one cutting edge that is arranged on a cutting surface that faces toward the central longitudinal axis of the annular holder, wherein each cutting insert comprises a holding profile that is arranged on a holding surface opposite the cutting surface. The receiving groove profiles of the receiving grooves and the holding profiles of the cutting inserts interact with each other in such a way that a cutting insert, when inserted into its receiving groove, is guided in the axial direction parallel to the central longitudinal axis of the annular holder and, in the fully inserted state, is clamped in a radial direction perpendicular to the central longitudinal axis of the annular holder.

### CROSS-REFERENCE TO RELATED APPLICATIONS

The present application is a continuation of international patent application Serial No. PCT/EP2012/053468, filed Feb. 29, 2012, which claims the benefit of German Patent Application Serial No. 10 2011 013 789.0, filed on Mar. 2, 2011, both of which are hereby incorporated by reference herein in their entirety, including any figures, tables, or drawings.

### BACKGROUND OF INVENTION

The disclosure relates to a die stock and to a holder and a cutting insert for such a die stock.

Die stocks, often also referred to as screw dies, are frequently used for machining of external threads and are known in various designs. In one design, die stocks are constructed in one piece as a HSS (High Speed Steel) tool. Although these are inexpensive to manufacture, they are limited in terms of performance and are uneconomical due to low cutting data. Furthermore, if a cutting edge is damaged, the entire die stock has to be exchanged. Die stocks which are made completely of hard metal as a one-piece tool are also known. These offer better performance, but are very expensive and complex in terms of manufacture. In addition thereto, die stocks with cutting inserts are known. However, due to the installation space conditions, these have less cutting inserts than the above-stated HSS die stocks and hard metal die stocks. Moreover, because of the space which is necessary for the insertion of the cutting inserts, they offer unfavorable stability of the tool.

### BRIEF SUMMARY

It is therefore an object to provide a die stock which overcomes the above-mentioned disadvantages.

In view of this object, there is provided a die stock comprising: an annular holder having a plurality of receiving grooves, a plurality of cutting inserts, and one fixture per cutting insert for axially fixing the respective cutting insert in one of the plurality of receiving grooves. The receiving grooves are provided on an inner periphery of the annular holder and run in an axial direction parallel to a central longitudinal axis of the annular holder. Each of the plurality of receiving grooves has a receiving groove profile for receiving one of the plurality of cutting inserts. Each cutting insert is received within a respective one of the receiving grooves and comprises at least one cutting edge that is arranged on a cutting surface that faces toward the central longitudinal axis of the annular holder. Each cutting insert further comprises a holding profile that is arranged on a holding surface opposite the cutting surface. The receiving groove profiles of the receiving grooves and the holding profiles of the cutting inserts interact with each other in such a way that a cutting insert, when inserted into its receiving groove, is guided in the axial direction parallel to the central longitudinal axis of the annular holder and, in the fully inserted state, is clamped in a radial direction perpendicular to the central longitudinal axis of the annular holder.

According to a further aspect, there is provided a holder for a die stock, which holder is of annular design and comprises a plurality of receiving grooves that are provided on an inner periphery of the annular holder and run in an axial direction parallel to a central longitudinal axis of the annular holder, wherein each of the plurality of receiving grooves has a receiving groove profile for receiving a cutting insert that has on a cutting surface directed toward the central longitudinal axis of the annular holder at least one cutting edge and on an opposite holding surface a holding profile. The receiving groove profile of each receiving groove interacts with the holding profile of the cutting inserts in such a way that the cutting insert, when inserted into its receiving groove, is guided in the axial direction and, in the fully inserted state, is clamped in the radial direction and fixed in the axial direction by means of a fixture.

According to a still further aspect, there is provided a cutting insert for a die stock, wherein the die stock has an annular holder having a plurality of receiving grooves which are provided on an inner periphery and run in an axial direction parallel to a central longitudinal axis of the annular holder, wherein each of the plurality of receiving grooves has a receiving groove profile for receiving the cutting insert, and wherein the die stock has one fixture per cutting insert in order to axially fix the cutting insert in the receiving groove. The cutting insert comprises on a cutting surface directed toward the central longitudinal axis of the annular holder at least one cutting edge, and has on an holding surface opposite the cutting surface a holding profile. The receiving groove profile of the receiving grooves and the holding profile of the cutting inserts interact with each other in such a way that the cutting insert, when inserted into its receiving groove, is guided in the axial direction, and, in the fully inserted state, is clamped in a radial direction perpendicular to the axial direction.

In the provided die stock, good stability is achieved by the cutting inserts being guided and held in a ring. Preferably, the annular holder is here made of HSS or other steel, while the cutting inserts are formed of hard metal. The cutting inserts are seated in corresponding receiving grooves provided on the inner periphery of the holder. The guidance and holding of the cutting inserts in the respective receiving grooves of the holder can be realized differently, wherein it is respectively ensured that an axial guidance of the cutting insert when inserted into its receiving groove is effected and wherein, following the insertion, the cutting insert is radially clamped in order to achieve exact positioning and thus high machining accuracy.

In the provided die stock, the cutting inserts are thus introduced from an end face of the holder in the axial direction, i.e. parallel to the holder longitudinal axis, into the corresponding receiving grooves and are not, as in known die stocks, designed via a ring as a one-piece element. Nor are they fitted in the radial direction from the inner side of the holder onto the holder or pillar-shaped holding elements. In comparison to known die stocks having changeable cutting inserts, more cutting inserts can hence be fitted onto the holder, whilst the spatial requirement remains the same.

All in all, the provided die stock, the provided holder and the provided cutting insert combine the advantages of the different designs of known die stocks. Since the holder per se can basically be made of simple steel, the manufacturing costs are significantly less than a one-piece die stock which is made entirely of hard metal. If a cutting insert is damaged, it is sufficient to exchange just this individual cutting insert, which, in the case of the provided die stock, is also easily possible without the holder having to be partially dismantled and/or other cutting inserts having to be removed or even exchanged. In addition, the provided die stock offers high machining accuracy and good stability.

It is preferably provided that the cutting inserts are of identical design. This leads to a further cost reduction, since different types of cutting inserts do not have to be made and provided to the user. Since, in such a case, for the use of the die stock for thread cutting, the cutting inserts can in principle not be identically positioned in the axial direction, further preferably axial positioning means are provided for the axial positioning of the cutting inserts in the respective receiving groove. Such axial positioning means can be, for example, spacer elements, which can be placed into the receiving grooves prior to the insertion of the respective cutting insert. These spacer elements can either be fixedly attached to the holder or be changeable, so that the axial positioning of the individual cutting inserts can also be varied, for example if cutting inserts are exchanged in order, for instance, to produce a thread with different pitch or with a different number of thread turns.

In a refinement, the holder comprises: a first holding ring, on which the receiving grooves are provided as continuous grooves, and a second holding ring, which is detachably connected to the first holding ring and which on its end face facing the first holding ring has as axial positioning means receiving recesses, which, in terms of number and positions, correspond with the number and the positions of the receiving grooves of the first holding ring and which are provided for the support and positioning, in the axial direction, of the respective cutting insert inserted in its receiving groove.

In this refinement, the axial positioning of the individual cutting inserts is thus determined by the depth of the receiving recesses in the second holding ring, though it is also conceivable that corresponding spacer elements can, if necessary, additionally be placed into these receiving recesses.

Alternatively, in another refinement it is provided that the holder is designed as a one-piece holding ring and that the axial length of the receiving grooves is designed differently for the desired axial positioning of the cutting inserts. This makes for a higher production complexity, however. In this solution also, corresponding spacer elements can, if necessary, be inserted into the receiving grooves.

Although it is advantageous that the cutting inserts are of identical design, it is alternatively also conceivable that the axial positioning of the cutting inserts is determined by the respective length of the cutting inserts in the axial direction, in which case the receiving grooves preferably have an identical axial length. Of course, also in this refinement of the cutting inserts, the receiving grooves can be designed differently long, or the holder can be designed in two parts, as described above, comprising a first holding ring and a second holding ring. Furthermore, spacer elements can here too additionally be used.

In a further refinement, it is provided that on the end face of the holder, from which the cutting inserts are introduced into the respective receiving groove, there is arranged for each receiving groove one fastening recess, which in the radial direction opens out into the receiving groove and which in the axial direction is adjoined by a threaded bore for the reception of a respective clamping screw for the axial clamping of the respective cutting insert in the receiving groove. On the one hand, an axial clamping of the cutting insert in the respective receiving groove is thereby achieved. In addition, it can thereby be achieved that over the end face of the holder, from which the cutting inserts are introduced into the respective receiving groove, there protrude no holding or clamping elements for fixing of the cutting inserts, so that the die stock can machine cut up to the facing stop imposed by the end face of the holder. Preferably, the fastening recesses are namely designed such that the fixture, inclusive of clamping screw, are received therein and, as far as possible, form with the end face of the holder a plane surface, or at least do not protrude beyond this.

Advantageously, it is further provided that the cutting inserts, in that region of the holding surface which in the inserted state is touched for fixing purposes by the respective fixture, has a projection in which the fixture engages. Both a secure axial and a secure radial clamping of the cutting insert can thereby be effected.

In addition, it is here preferably provided that the fixture has per cutting insert a clamping screw and a clamping plate acting on the cutting insert, wherein the clamping plate and that clamping surface of the projection on which this acts, run in the same way obliquely to the holder longitudinal axis, so that the cutting insert, when fixed by the fixture, is pulled in the radial direction into the receiving groove. Such a refinement helps to further increase the radial and axial fixing of the cutting insert in its receiving groove.

In one refinement, it is provided that that contact surface of the cutting insert which in the inserted state of a cutting insert is supported against a supporting surface of the holder, and the supporting surface of the holder, run in the same way obliquely to the holder longitudinal axis, so that the cutting insert, when fixed by the fixture, is pulled in the radial direction into the receiving groove. This measure, too, further helps to fix the cutting insert as tightly as possible in the receiving groove.

In principle, the guidance and fixing can be realized differently. In another refinement, it is provided by way of example that the receiving groove profile and the holding profile have a (in particular wedge-shaped) cross section, which becomes increasingly narrow with increasing distance from the holder longitudinal axis. Inversely configured wedge shapes or cylindrical cross-sectional shapes are also, however, usable in principle. In other refinements, it is provided that the receiving groove profile and the holding profile have a cross-sectional profile, which profiles interact with each other in the manner of a rail, a tongue and groove or a toothing.

The number of cutting edges on the cutting inserts can be chosen according to the purpose of use. In many applications, one cutting edge per cutting insert is sufficient. In the thread cutting, cutting inserts having a multiplicity of cutting edges are frequently used, however. The cutting edges themselves can all be of identical design, but can also be of different design, in order to achieve the desired metal cutting effect in successive work steps by virtue of the different cutting edges.

It shall be noted that the features which are mentioned above and those which have yet to be explained below are usable not only in the respectively stated combination, but also in different combinations or on their own without departing from the scope of the present disclosure.

### BRIEF DESCRIPTION OF DRAWINGS

Further features and advantages of the disclosure emerge from the description below of a plurality of preferred exemplary embodiments with reference to the drawings, in which:

FIG. 1 shows a perspective front view of a die stock according to an embodiment.

FIG. 2 shows an exploded representation of a die stock according to an embodiment.

FIG. 3A shows a perspective front view and FIG. 3B shows a rear view of a first holding ring of the provided die stock.

FIG. 4 shows a perspective front view of a second holding ring of the provided die stock.

FIGS. 5A-5D show various views of a provided cutting insert of the provided die stock, where FIG. 5A shows a first perspective side view of a first longitudinal side A, FIG. 5B shows a second perspective side view of the first longitudinal side 3A, FIG. 5C shows a top view of the upper end face 3B, and FIG. 5D shows a side view of the second longitudinal side 3C.

FIG. 6 shows a sectional representation through a part of the provided die stock.

### DETAILED DISCLOSURE

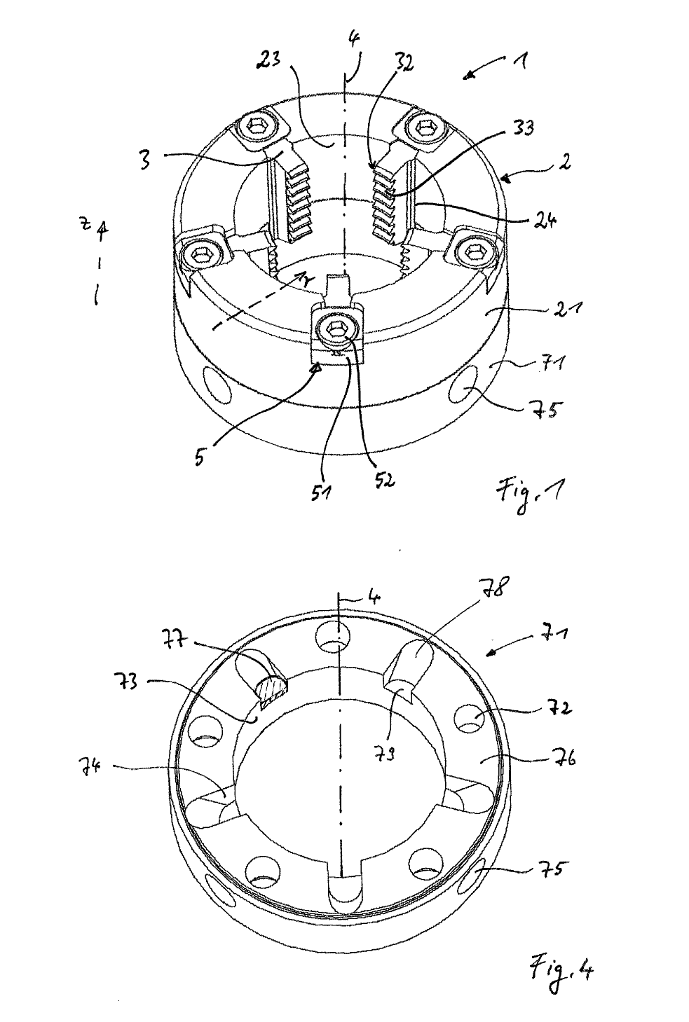

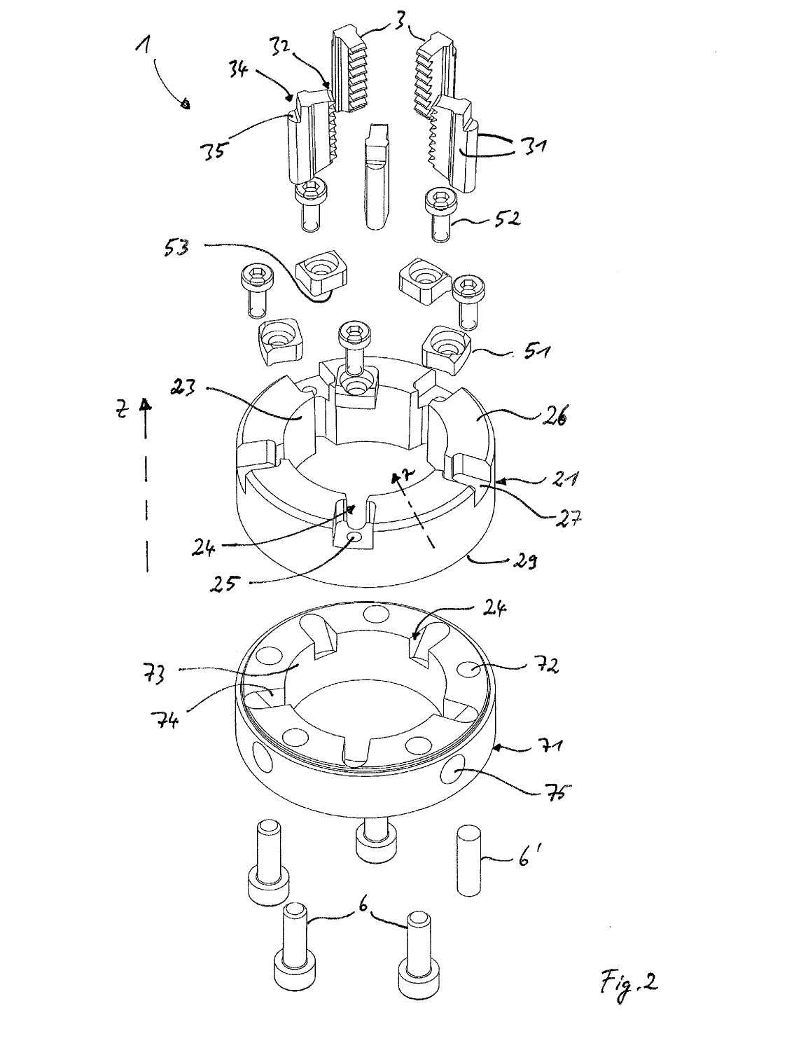

FIG. 1 shows a perspective front view of a die stock 1 and FIG. 2 shows an exploded representation of this die stock 1. This die stock 1 has an annular holder 2, which in the shown illustrative embodiment is formed of two holding rings 21, 71, but can also in principle be configured in one piece. Attached to this holder 2, on the inner periphery 23, 73, are a plurality of (in this illustrative embodiment five) cutting inserts 3, which are respectively arranged in a receiving groove 24 formed in the axial direction z in the holder 2. These receiving grooves 24 have a corresponding receiving groove profile, which corresponds with a correspondingly designed holding profile (here a V-profile, which is formed by opposite holding surfaces 31 and, between these, a radius 30) on the rear longitudinal side of the cutting inserts 3, so that a cutting insert 3 in the corresponding receiving groove, when inserted, is guided in the axial direction z and, in the fully inserted state, is clamped in the radial direction r.

On that longitudinal side of the cutting inserts 3 which lies opposite the holding profile 30, 31 is respectively provided a cutting surface 32, which cutting surfaces have at least one cutting edge 33, in the present case a multiplicity of cutting edges. In the assembled die stock 1, as shown in FIG. 1, these cutting edges 33 are directed toward the central holder longitudinal axis 4, so that a workpiece (not shown) arranged along the holder longitudinal axis 4, for example a tube or a rod can be machined in order to provide, for example, an external thread.

In order to axially fix the respective cutting insert 3, by the end face, in the associated receiving groove 24 of the holder, suitable holding means 5 (also denoted as fixture 5) are provided. These holding means 5 are formed in the shown embodiment by a clamping plate 51 and a clamping screw 52. The clamping plate 51 has a central bore, through which the clamping screw 52 can be screwed into an internally threaded bore 25 running in the z direction on the first holding ring 21. In the upper end face 26 of the first holding ring 21 are provided, for the reception of the clamping plate 51, corresponding fastening recesses 27, which respectively in the radial direction open out into the receiving groove 24 and in the floor of which is drilled said threaded bore 25.

As can be seen, in particular, from FIG. 2, the cutting inserts 3 have on their outwardly directed longitudinal side a projection 34, in which the clamping plate 51 engages with its downwardly directed bottom side 53 for the radial and axial fixing of the cutting insert 3. Preferably, both the clamping plate 51, or its inwardly directed bottom side 53, and that clamping surface 35 of the projection 34 which is thereby acted on, here run in the same way obliquely to the holder longitudinal axis 4, so that the cutting insert 3, when fixed by the clamping plate 51, is pulled in the radial direction r into the receiving groove 24.

From FIG. 2 it can also be seen that in the present illustrative embodiment the two holding rings 21, 71 of the holder 2 are screwed together by holding screws 6, which, through bores 72 in the second holding ring 71, are screwed into corresponding threaded bores on that end face 29 of the first holding ring 21 which is directed toward the second holding ring 71. In addition, one or more pins 6′ can be provided to connect and fix the ring in the holder.

In the shown illustrative embodiment, furthermore, on the outer periphery of the second holding ring 71 are provided a plurality of holding bores 75, by means of which the die stock can be secured in a die stock holder (not shown), a machine tool, or otherwise.

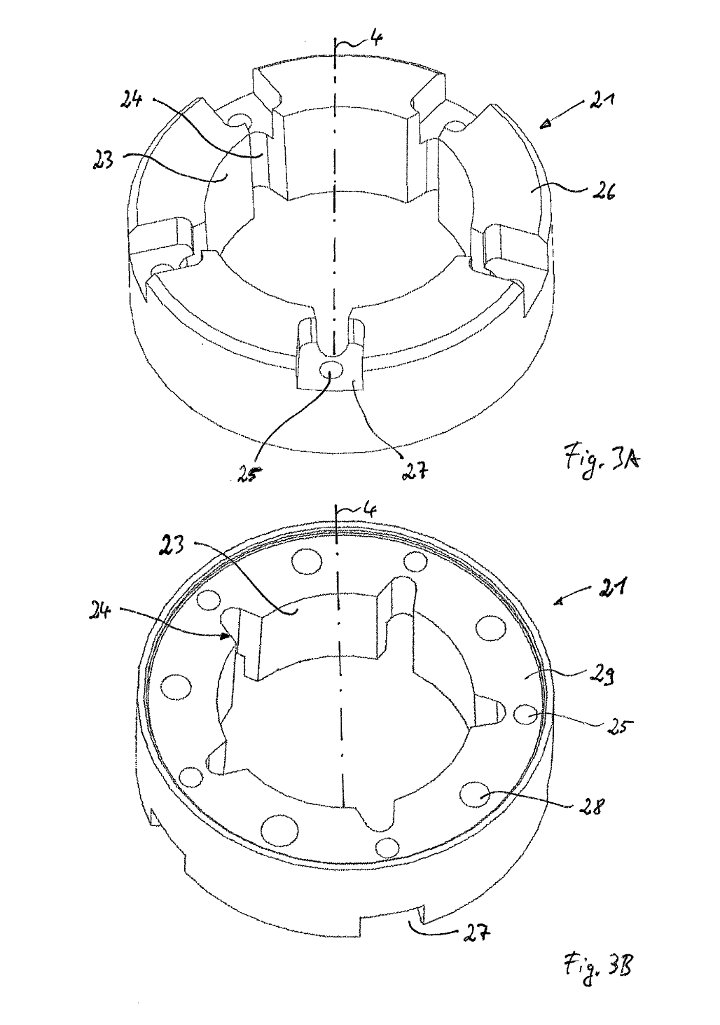

FIG. 3 shows various views of the first holding ring 21, namely a perspective front view (FIG. 3A) and a perspective rear view (FIG. 3B). In the rear view, the threaded bores 25, into which the clamping screws 52 are screwed (from the front end face 26) for fastening of the clamping plate 51 in the respective fastening recess 27, can likewise be recognized there. It should be mentioned, however, that these threaded bores 25 must not be realized such that they run continuously through to the bottom end face 29. In addition, the fastening bores 72, into which the fastening screws 6 can be screwed or the pin 6′ can be inserted for screwing together of the two holding rings 21, 71, can also be seen.

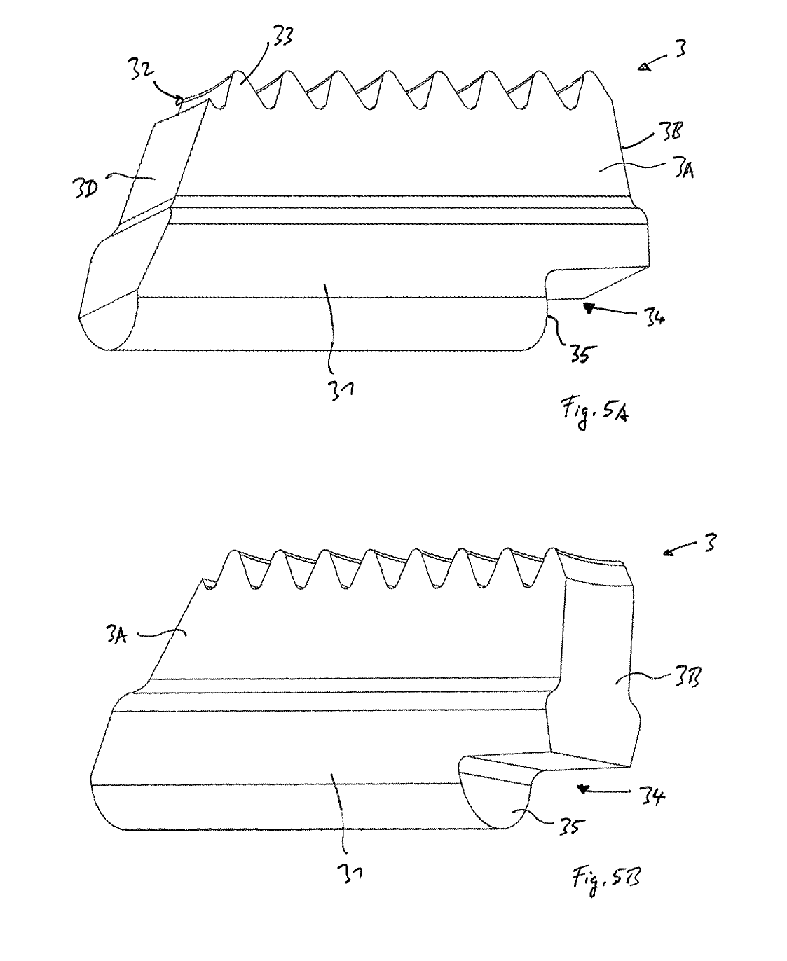

FIG. 4 shows a perspective front view of the second holding ring 71 of the provided die stock 1. Here it can clearly be seen that the bottommost part of the receiving groove 24 does not run continuously through the second holding ring 71, but is respectively configured as a receiving recess 74, which receiving recesses, of course, in terms of number and position, correspond with the number and the positions of the receiving grooves 24 of the first holding ring 21. These receiving recesses 74 are designed such that the associated cutting insert 3, in the inserted state, rests with its bottom side thereon in the axial direction and positions the cutting insert 3 in the axial direction.

For this positioning, the receiving recesses 74 can be drilled, for example, to different depth into the second holding ring 71, viewed from its upper end face 76. Alternatively or additionally, corresponding spacer elements 77 (such a spacer element is indicated in FIG. 4 in a receiving recess 74) can be used for this purpose, which spacer elements can be placed into the respective receiving recess 74 prior to the insertion of the respective cutting insert 3. Axial positioning means of this type are provided, in particular, when the cutting inserts 3 all have an identical length, since, for the production of a thread, the cutting inserts 3 are usually arranged slightly mutually offset in the axial direction. The receiving recesses 74 cut to different depth are here the easiest option for fixed axial positioning. Should the cutting inserts 3 be exchanged, however, in order, for example, to produce a thread of different pitch or an in any way different thread, the described spacer elements 77 can additionally be used.

On the floor of the receiving recess can be arranged a flat supporting surface, or one or two (as shown in FIG. 4) supporting surfaces 78, 79 running obliquely to each other, which are provided to support the cutting insert 3 and are tailored to the corresponding contact surface of the cutting insert 3.

Alternatively, various second holding rings 71 having differently deep receiving recesses 74 can instead be provided, which second holding rings then thus bring about a changed axial positioning of the cutting inserts 3. In such a case, the user can then, in addition to a single first holding ring 21, be provided with a set of differently designed second holding rings 71 and different sets of cutting inserts 3 if this die stock is intended to be used to make different threads. Of course, it is also respectively conceivable in this context that the cutting inserts 3 can reach differently far into the interior of the die stock in order to machine different workpieces.

Alternatively, it is also, of course, conceivable that just a single second holding ring 71 having receiving recesses 74 of equal depth is provided, and that the axial positioning of the various cutting inserts is provided by cutting inserts of different length, so that the respective length of the individual cutting inserts thus determines their axial position.

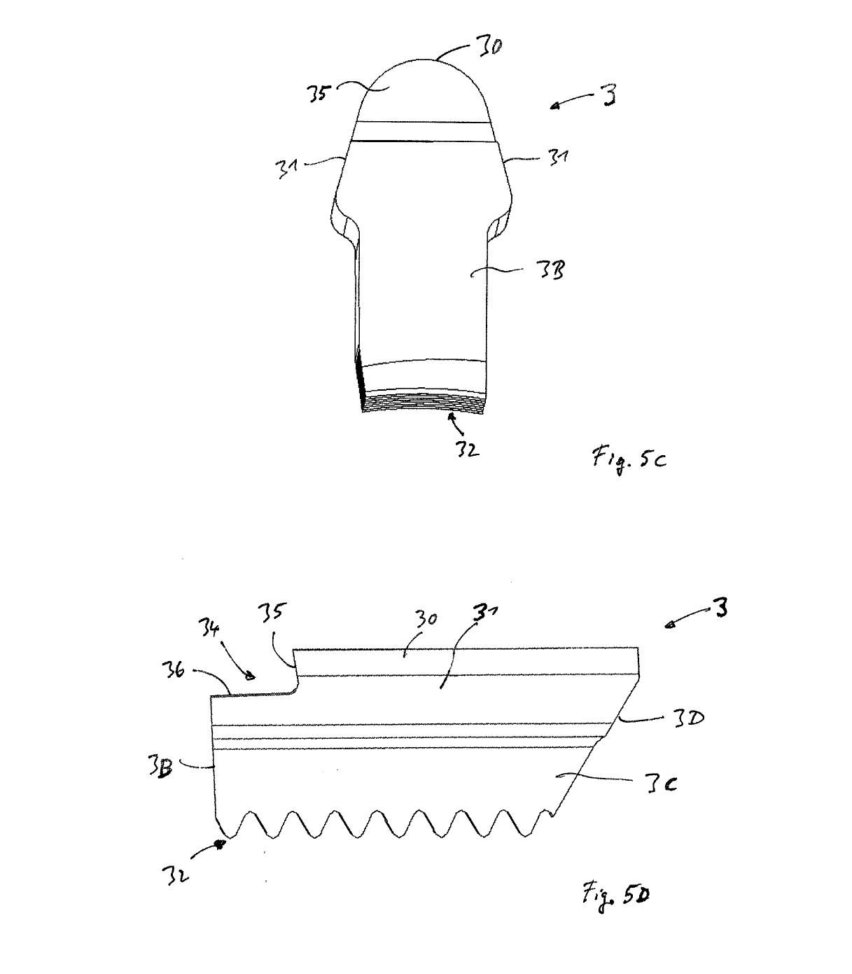

FIG. 5 shows a cutting insert 3 of the provided die stock 1 in various views, namely in a first perspective side view of a first longitudinal side A (FIG. 5A), a second perspective side view of the first longitudinal side 3A (FIG. 5B), a top view of the upper end face 3B (FIG. 5C), and a side view of the second longitudinal side 3C (FIG. 5D). As can be seen, in particular, from FIG. 5, the holding surfaces 31 form together with the radius 30 a holding profile, which has a cross section that becomes narrower with increasing distance from the holder longitudinal axis 4, i.e. from the cutting surface 32. The receiving groove profile of the receiving grooves 24 (cf. FIGS. 3A, 3B) is correspondingly designed, so that the receiving groove 24 offers an axial guide for the cutting insert 3 when this is inserted into its receiving groove 24. In particular, the cross section of the holding profile is, for this purpose, formed in a wedge shape, as can be seen in FIG. 5C.

However, it is also, of course, conceivable to use other cross-sectional profiles for the receiving groove profile and the holding profile, for example cross-sectional profiles which interact with each other in the manner of a rail, a tongue and groove or a toothing and bring about the axial guidance of the cutting insert 3 in its receiving groove 24. The cross-sectional profiles can here also be designed such that, even without fastening of the cutting insert by means of holding means, the cutting insert, when introduced, can no longer fall radially out of the receiving groove.

As can be seen, in particular, from FIG. 5D, the base 35 of the projection 34 runs slightly obliquely, i.e. not precisely at an angle of 90° to the vertical contact surface 36 of the projection, but at a slightly lesser angle than 90° (for example within the range between 60° and 89°). This obliquely running base surface 35 is acted on by the bottom side 53 of the clamping plate 51, which runs in a similar same way obliquely to the holder longitudinal axis 4. This has the effect that the cutting insert 3, when fixed by the clamping means, thus if the clamping plate 51 is screwed by means of the clamping screw 52 tightly against the cutting insert 3, that the cutting insert 3 is not only pressed in the axial direction into the receiving groove 24, but is also pulled in the radial direction into the receiving groove 24.

In addition, it can be seen, in particular, from FIG. 5D, that the contact surface 3D of the cutting insert 3, which, when the cutting insert is inserted, reaches into the receiving groove 24 of the second holding ring 71, runs obliquely to the holding surfaces 31 and thus also obliquely to the holder longitudinal axis 4, for example at an angle between holding surfaces 31 and contact surface 3D within the range from 0° to 60°, preferably within the range between 15° and 45°. In the same or similar fashion, the corresponding supporting surface 79 (cf. FIG. 4) on the floor of the receiving recess 74 is obliquely configured. This has the effect that the cutting insert, when fixed by the holding means, is pulled in the radial direction into the receiving groove 24, which additionally helps to fix the cutting insert 3 as tightly and securely as possible in the receiving groove 24.

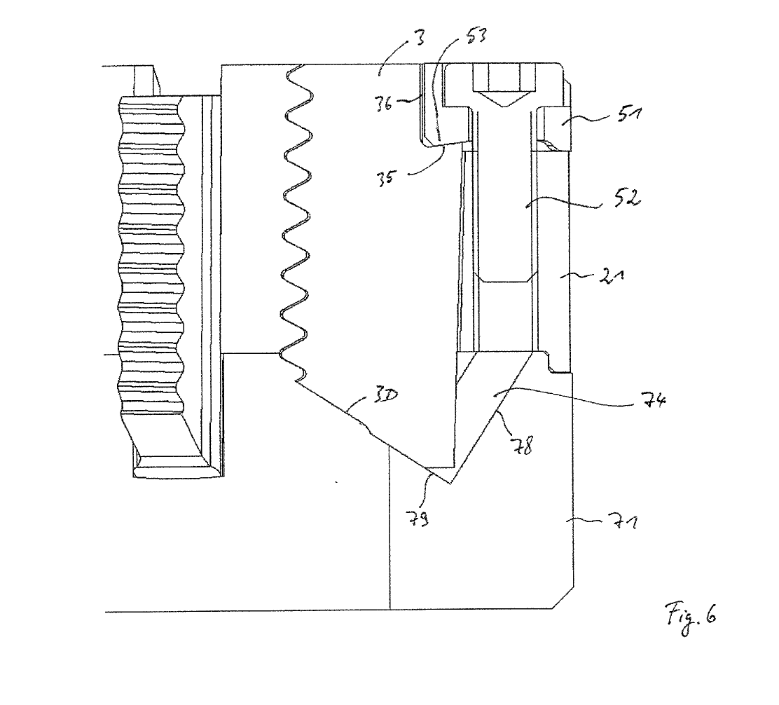

FIG. 6 shows a cross section through a part of the provided die stock. There, the position of a cutting insert 3 in the receiving groove 24 and the receiving recess 74, as well as the fixing by means of the clamping plate 51 and the clamping screw 52, are evident. In particular, it can be seen how the inwardly directed, obliquely running bottom side 53 of the clamping plate 51 acts on the likewise obliquely running clamping surface 35 of the cutting insert 3 and fixes the cutting insert 3 in the radial direction. At the same time, the cutting insert 3 is thereby fixed in the axial direction.

Self-evidently, the present invention is not limited to the illustrative embodiment shown in the figures and explained above. Numerous variants are conceivable without departing from the scope of the present invention. The shown and described individual features can also respectively be mutually combined in other combinations. In particular, the number and basic design of the cutting inserts plays no significant role for the present invention. According to the purpose of use, these can be chosen correspondingly.

The provided die stock enables a simple and rapid exchange of individual or all cutting inserts. The cutting inserts are respectively reliably guided and positioned both in the axial and in the radial direction, whereby a desired high machining accuracy is achieved. In addition, preferably only the cutting inserts are produced from hard metal, while the holder itself can be made from less expensive steel.

Aspects of the invention may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, transitory and non-transitory, transient and non-transient media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile disks (DVD), holographic media or other optical disk storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A die stock, comprising:
an annular holder having a plurality of receiving grooves;
a corresponding plurality of cutting inserts; and
a corresponding plurality of fixtures, wherein each fixture axially fixes a respective cutting insert in a respective receiving groove,
wherein the plurality of receiving grooves are provided on an inner periphery of the annular holder and run in an axial direction parallel to a central longitudinal axis of the annular holder, wherein each receiving groove of the plurality of receiving grooves has a receiving groove profile for receiving a respective cutting insert,
wherein each cutting insert of the plurality of cutting inserts is received within a respective receiving groove of the plurality of receiving grooves, wherein each cutting insert of the plurality of cutting inserts comprises at least one cutting edge that is arranged on a cutting surface that faces toward the central longitudinal axis of the annular holder, and wherein each cutting insert of the plurality of cutting inserts comprises a holding profile that is arranged on a holding surface opposite the cutting surface,
wherein the receiving groove profile of each receiving groove of the plurality of receiving grooves and the holding profile of each cutting insert of the plurality of cutting inserts interact with each other in such a way that each cutting insert, when inserted into the respective receiving groove, is guided in the axial direction parallel to the central longitudinal axis of the annular holder and, in a fully inserted state, is clamped in a radial direction perpendicular to the central longitudinal axis of the annular holder.

2. The die stock as claimed in claim 1, wherein the plurality of cutting inserts are of identical design.

3. The die stock as claimed in claim 2, wherein the annular holder comprises an axial positioning means for axially positioning each cutting insert in the respective receiving groove.

4. The die stock as claimed in claim 3, wherein the axial positioning means comprises one or more spacer element, wherein one or more spacer element is arranged on a corresponding at least one base surface of at least one receiving groove of the plurality of receiving grooves below the respective at least one cutting insert.

5. The die stock as claimed in claim 3, wherein the annular holder further comprises:
a first holding ring, on which the plurality of receiving grooves are provided as continuous grooves, and
a second holding ring, wherein the second holding ring is detachably connected to the first holding ring, wherein the axial positioning means comprises a plurality of receiving recesses on an end face of the second holding ring facing the first holding ring, wherein a number of and positions of the plurality of receiving recesses correspond with a number of and positions of the plurality of receiving grooves of the first holding ring, wherein the plurality of receiving recesses provide support and positioning of the plurality of cutting inserts in the axial direction.

6. The die stock as claimed in claim 5, wherein at least one receiving recess of the plurality of receiving recesses comprises a corresponding at least one spacer element, wherein each of the at least one spacer element is arranged on a respective base surface of the at least one receiving recess.

7. The die stock as claimed in claim 1, wherein axial positioning of each cutting insert of the plurality of cutting inserts is determined by a respective length of the respective cutting insert in the axial direction.

8. The die stock as claimed in claim 7, wherein the plurality of receiving grooves each have an identical axial length.

9. The die stock as claimed in claim 1, wherein on an end face of the annular holder, from which the plurality of cutting inserts can be introduced into the plurality of receiving grooves, a corresponding plurality of fastening recesses is arranged such that for each receiving groove, a respective fastening recess opens out in the radial direction into the respective receiving groove, the respective fastening recess is adjoined in the axial direction by a respective threaded bore of a corresponding plurality of threaded bores for receiving a respective clamping screw of a corresponding plurality of clamping screws for axially clamping the respective cutting insert in the respective receiving groove.

10. The die stock as claimed in claim 1, wherein each cutting insert of the plurality of cutting inserts comprises a projection in a region of the holding surface that, in an inserted state, is touched for fixing purposes by a respective fixture of a corresponding plurality of fixtures, wherein the projection engages the respective fixture.

11. The die stock as claimed in claim 10, wherein each fixture of the plurality of fixtures comprises a clamping screw and a clamping plate, wherein the clamping plate and a clamping surface of the respective projection on which the clamping plate acts, run in the same way obliquely to the central longitudinal axis of the annular holder, such that the respective cutting insert, when fixed by the respective fixture, is pulled in the radial direction into the respective receiving groove.

12. The die stock as claimed in 1, wherein a contact surface of each cutting insert, when the cutting insert is in an inserted state, is supported against a supporting surface of the annular holder, wherein the supporting surface of the annular holder runs in the same way obliquely to the central longitudinal axis of the annular holder, such that the cutting insert, when fixed by the fixture, is pulled in the radial direction into the respective receiving groove.

13. The die stock as claimed in claim 1, wherein the receiving groove profile and the holding profile have a wedge-shaped cross section that becomes increasingly narrow with increasing distance from the central longitudinal axis of the annular holder.

14. The die stock as claimed in claim 1, wherein the receiving groove profile and the holding profile interact with each other in the manner selected from the group consisting of a rail, a tongue and groove, or a toothing.

15. The die stock as claimed in claim 1, wherein each of the cutting inserts comprises a multiplicity of cutting edges arranged side by side.

16. A holder for a die stock, comprising:
a plurality of receiving grooves, wherein the holder is an annular holder, wherein the plurality of receiving grooves are provided on an inner periphery of the annular holder and run in an axial direction parallel to a central longitudinal axis of the annular holder, wherein each receiving groove of the plurality of receiving grooves has a receiving groove profile for receiving a respective cutting insert of a corresponding plurality of cutting inserts, wherein the respective cutting insert has at least one cutting edge on a cutting surface directed toward the central longitudinal axis of the annular holder, wherein the cutting insert has a holding profile on a holding surface opposite the cutting surface,
wherein the receiving groove profile of each receiving groove of the plurality of receiving grooves interacts with the holding profile of the respective cutting insert in such a way that the respective cutting insert, when inserted into the respective receiving groove, is guided in the axial direction and, in a fully inserted state, is clamped in a radial direction and fixed in the axial direction by a fixture.

17. A cutting insert for a die stock, comprising:
a cutting surface, wherein the cutting insert is configured to be received by a die stock, wherein the die stock has an annular holder having a plurality of receiving grooves, wherein the plurality of receiving grooves are provided on an inner periphery of the annular holder and run in an axial direction parallel to a central longitudinal axis of the annular holder, wherein each receiving groove of the plurality of receiving grooves has a receiving groove profile for receiving the cutting insert, wherein the die stock has one fixture per cutting insert in order to axially fix the cutting insert in the receiving groove; and
at least one cutting edge on the cutting surface, wherein the at least one cutting edge is directed toward the central longitudinal axis of the annular holder when the cutting insert is received by the die stock, wherein the cutting insert has a holding profile on a holding surface opposite the cutting surface,
wherein the receiving groove profile of the receiving groove that receives the cutting insert when the cutting insert is received by the die stock and the holding profile of the cutting insert interact with each other in such a way that the cutting insert, when inserted into the receiving groove that receives the cutting insert when the cutting insert is received by the die stock, is guided in the axial direction, and, in a fully inserted state, is clamped in a radial direction perpendicular to the axial direction.
